(19) United States
(12) Patent Application Publication
(10) Pub. No.: US 2003/0077003 A1
(43) Pub. Date: Apr. 24, 2003

(54) Image processing method for enlarging and compensating the pixel of digital video data according to viewpoint

(75) Inventor: Car-Lai Ma, Taipei (TW)

Correspondence Address: BACON & THOMAS, PLLC, 625 SLATERS LANE, FOURTH FLOOR, ALEXANDRIA, VA, 22314

(73) Assignee: Tiger Color Inc.,, Taipei (TW)

(21) Appl. No.: 09/983,452

(22) Filed: Oct. 24, 2001

(51) Int. Cl. G06K 9/32

(52) U.S. Cl. 382/299

(57) ABSTRACT

The present invention relates to an image processing method for enlarging and compensating the pixel of digital video data according to viewpoint, which performs an enlargement on a digital video data by using point interpolation computation technology to simulate at least one pixel between the original plurality of adjacent pixels, and allocates the color value of each original pixel to the simulated pixel by weight according to the distance between the original pixel and the simulated pixel, thereby enabling the enlarged digital video data to have finer resolution and better color due to the compensation of the simulated pixel.

### BACKGROUND OF THE INVENTION

1) Field of the Invention

The present invention relates to an image processing method for enlarging and compensating the pixel of digital video data according to viewpoint.

2) Description of the Related Art

Electronic technologies have known a rapid and a spectacular development leading to an increasing performance of computers and peripherals thereof. Further, a variety of inexpensive software are continuously available. This in turn makes computers and peripherals more popular among consumers for facilitating daily life, learning, and so on. For taking advantage of such trend, many AV product manufacturers endeavor to develop digitized products for attracting the newly formed many computer consumers. For example, in the case of digital camera, manufacturers usually give free image processing software when user buys a digital camera, thereby attracting more consumers to buy their products. By utilizing the image processing software, user may read the fetched digital image representation from digital camera and show the same from screen of a connected computer or TV. Alternatively, user may edit image therein. This has the benefits of saving cost of printing photographs, customizing digital image representation, saving storage space and related resources, and so forth.

In all kinds of the current image processing software, it generally provides editing function for the digital video data, and has the function of viewing the digital video data to enlarge or reduce the image. Such enlargement and reduction function allows the user to enlarge or reduce the opened digital video data on a computer screen, or review and edit the digital video data. However, since the prior-art image processing software performs enlargement on the digital video data 10 by clicking the enlarge object icon 12 in the toolbox 11 (as shown in FIG. 1) for the enlargement of the digital video data 10. The traditional image processing software does not allow the user to review a specific portion of the digital video data according to the user's need, but just uses the central position of the digital video data to extend outward for the enlargement (referring to FIG. 2) such that the images at edges around the image frame 13 of such digital video data 10 cannot be shown in the image frame 13. This processing method is very inconvenient when the user needs to review and edit a certain portion of the digital video data since it creates many blind spots on the reviewing and editing.

Furthermore, the conventional image processing software performs enlargement on the reviewing digital video data, the original pixel of such digital video data will be enlarged in equal proportion that will give rise to the problems of serrate edges and uneven color. Please refer to FIG. 3. Take the four pixels A, B, C, and D adjacent to the digital video data for example, if the pixel of the digital video data has not been enlarged, the color of each of the pixel of the four adjacent pixels 21 on the screen will be shown. When the image is enlarged by 4 times, the four pixels show the color of each pixel. Then if the color difference between each of the pixels is too large, it will have the problem of serrate profile and uneven color on the digital video data when it is enlarged. Please refer to FIG. 4. Such phenomenon does not only make the digital video data unfitted, but also makes the user uninterested to edit such digital video data any further, which greatly reduce the function of the image processing software.

### SUMMARY OF THE INVENTION

In view of all kinds of the current image processing software, when it reviews the digital video data and performs enlargement, it is unable to review a specific portion of the image according to the user's need. In addition, the digital video data after enlargement generally have the problems of serrate profile and uneven color. The present invention provides an image processing method for enlarging and compensating the pixel of digital video data according to viewpoint, and the enlarged digital video data by such method has a finer resolution and better color, which greatly enhances the image quality of such digital video data after enlargement.

The primary objective of the present invention is to provide an image processing method by using the point interpolation computation technology for the original plurality of adjacent pixels to simulate at least one pixel when the digital video data is enlarged. Furthermore, The color value of the original pixel between the original pixels and the simulated pixels will be allocated to the simulated pixel by weighting such that after the digital video data is enlarged. The compensation for the simulated pixels gives a more finer resolution and a better color, and also avoids to have the problems of serrate profile and uneven color.

Another objective of the present invention is to provide an image processing method by using the input device to click the position on a digital video data as the center of a viewpoint for the enlargement of the digital video data. The users can review any specific portion of the digital video data according to their needs.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows a digital video data of a prior-art image processing software on a computer screen.

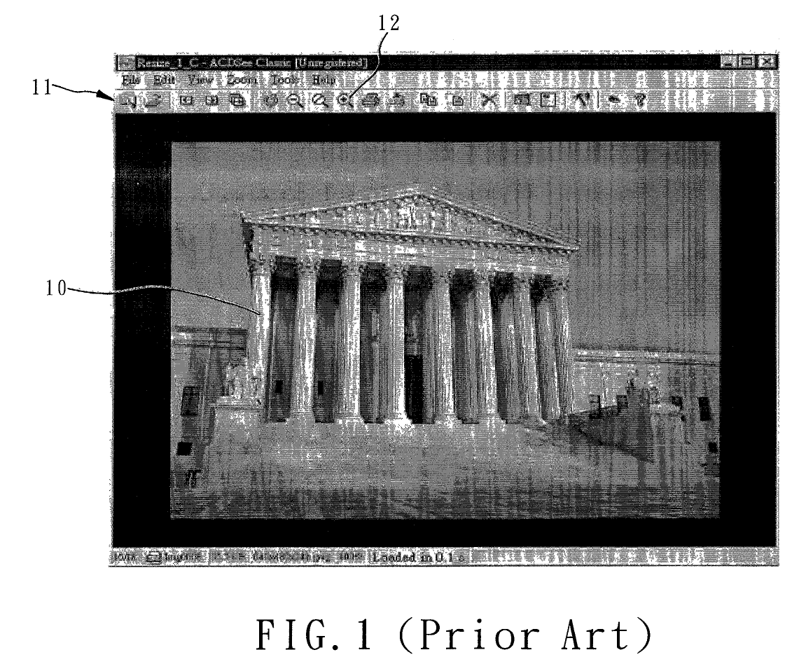

FIG. 2 shows the screen of performing the enlargement of the digital video data by the image processing software as depicted in FIG. 1.

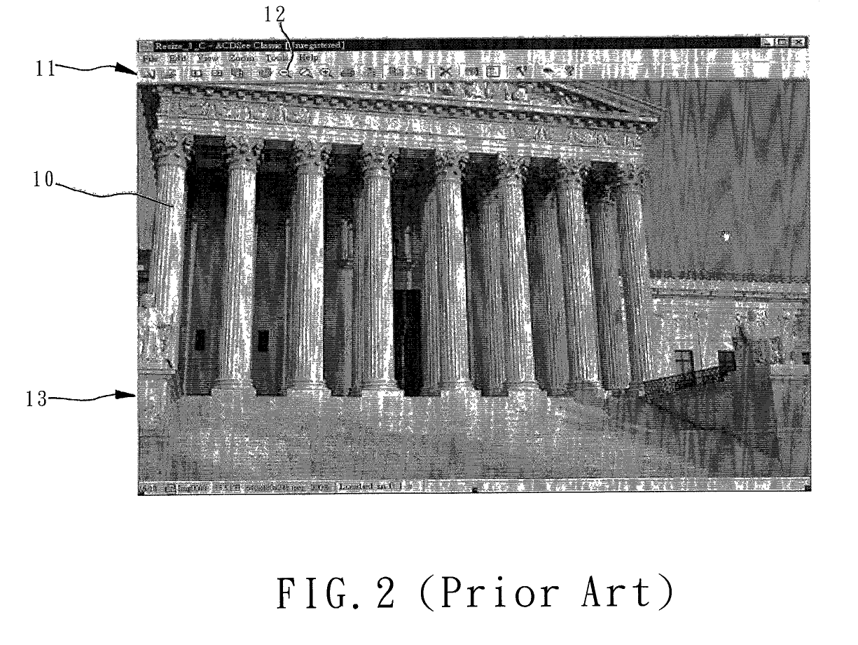

FIG. 3 shows the status after the enlargement for the four adjacent pixels on the digital video data as depicted in FIG. 2.

FIG. 4 shows the screen of the image with serrate profile and uneven color after enlargement of the digital video data as depicted in FIG. 2.

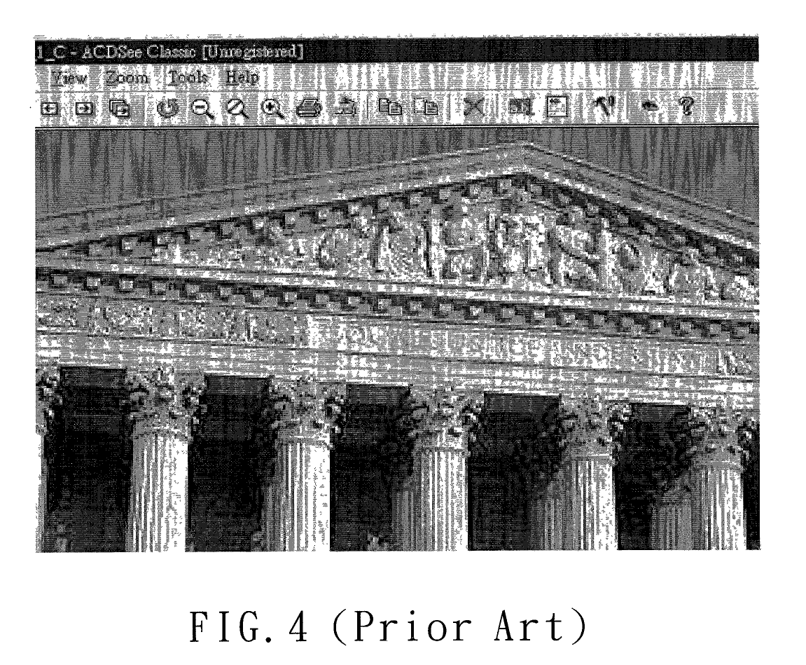

FIG. 5 shows the change of the corresponding pixels after the four pixels on the digital video data has been enlarged for several times.

FIG.6 shows the screen of using the enlarge object to enlarge the digital video data according to the present invention.

FIG. 7 shows the relation between the pixel of the simulated pixel V_{XY} after the adjacent four pixels of the digital video data is enlarged and the original pixels A, B, C, and D according to the present invention.

FIG. 8 shows the screen of the enlarged digital video data of the enlarged object by using an input device to select the position of such digital video data as the center of the viewpoint according to the present invention.

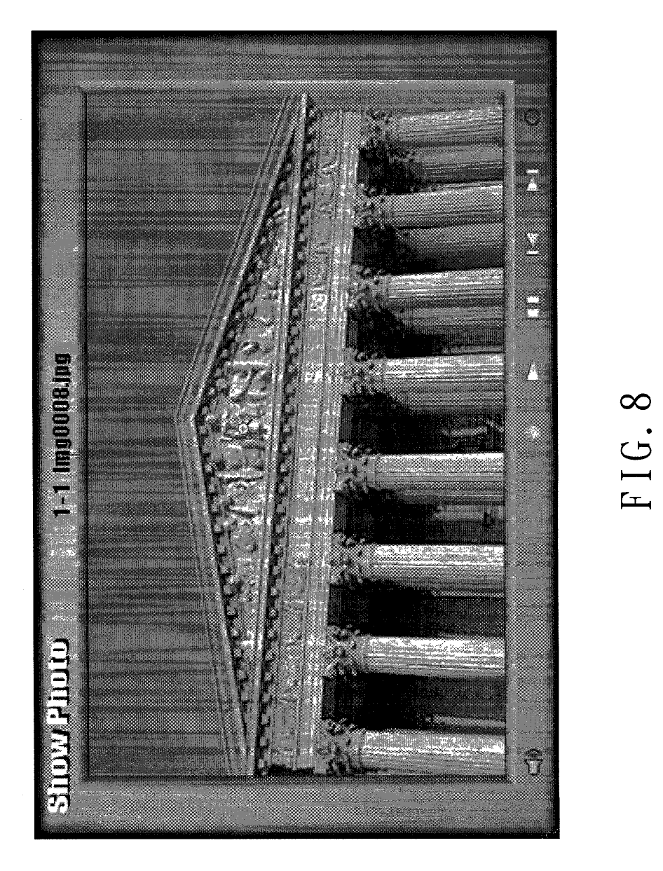

### DETAILED DESCRIPTION OF THE PREFERRED EMBODIMENTS

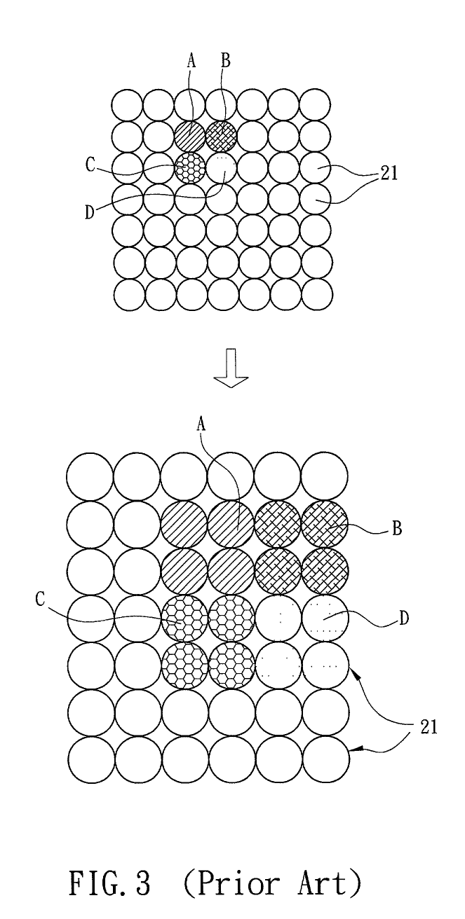

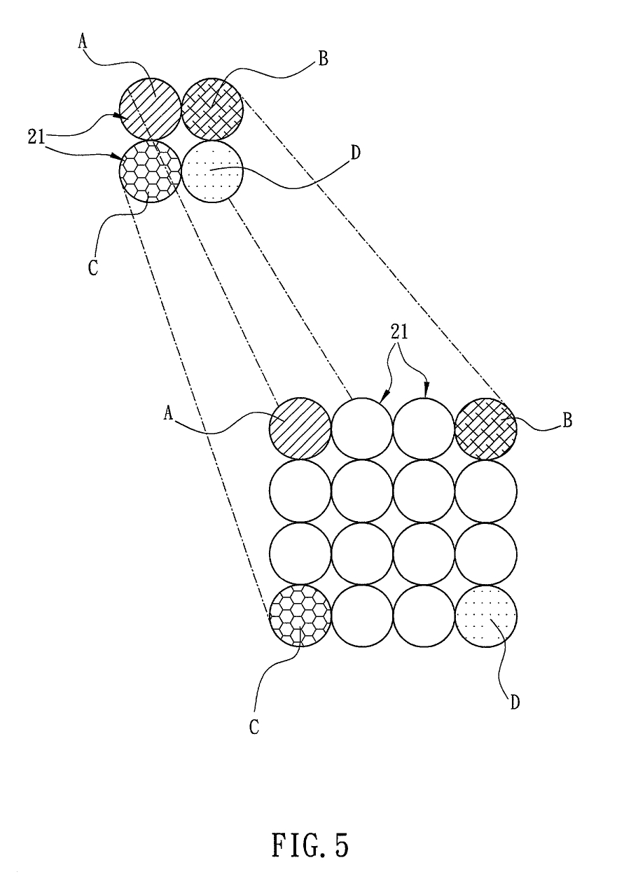

Please refer to FIG. 5. When an image processing software shown on a computer screen performs an enlargement on a digital video data, the color of the four adjacent pixels A, B, C, D of the pixel 21 will corresponds to four pixels 21 on the computer screen to show their color according to the times of enlargement after it is enlarged. Therefore, when the digital video data is enlarged for 4 times, the distance between the four adjacent pixels 21 in the corresponding positions will be increased by 2 times compared with the distance between the original pixels before enlargement. The number of pixels included in the four pixels A, B, C, and D on the computer screen will be increased from 4 to 16. As mentioned above, when the traditional image processing software enlarges the adjacent four pixels A, B, C, and D of the digital video data, the color of each of the pixels A, B, C, and D will be allocated in equal proportions to the extended pixels for the digital video data displayed on the computer screen. Please refer to FIG. 3. Thus, if the color difference of the pixels is too large, then the digital video image after being enlarged will have the problems of serrate profile and uneven color.

The present invention focuses on the shortcomings of the prior-art image processing software after enlarging the digital video data to provide an image processing method to enlarge the digital video data according to the viewpoint and perform pixel compensation. When an image processing software performs an enlargement on a digital video data by such method, it simulates at least one pixel between the original plurality of adjacent pixels and allocates the color value of the original pixel between the original pixels and the simulated pixels by weighting such that after the digital video data is enlarged, the compensation of the simulated pixel has a finer resolution and better color. It can avoid the problems of serrate profile and uneven color, and thus greatly enhances the image quality of the enlarged digital video data.

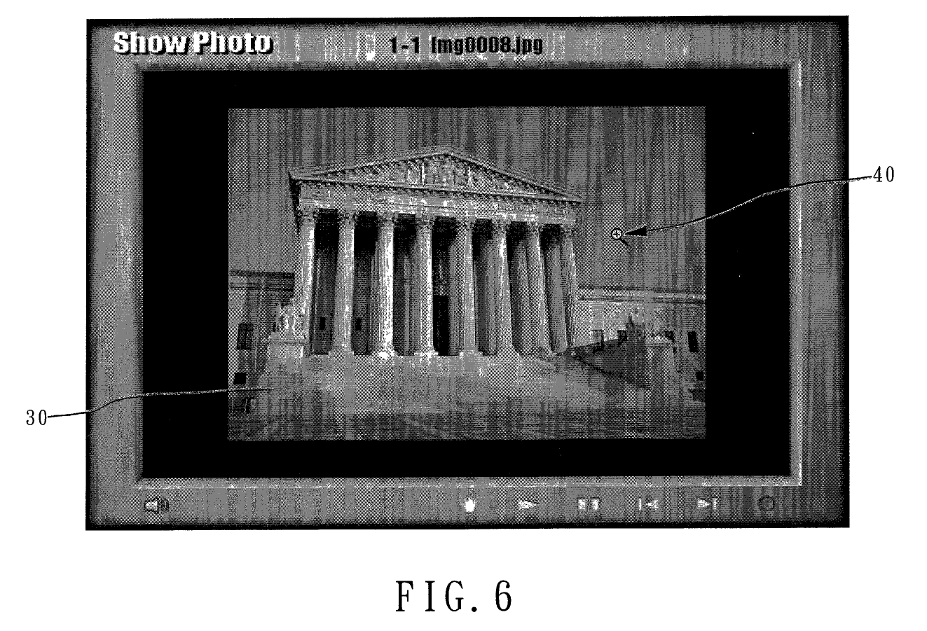

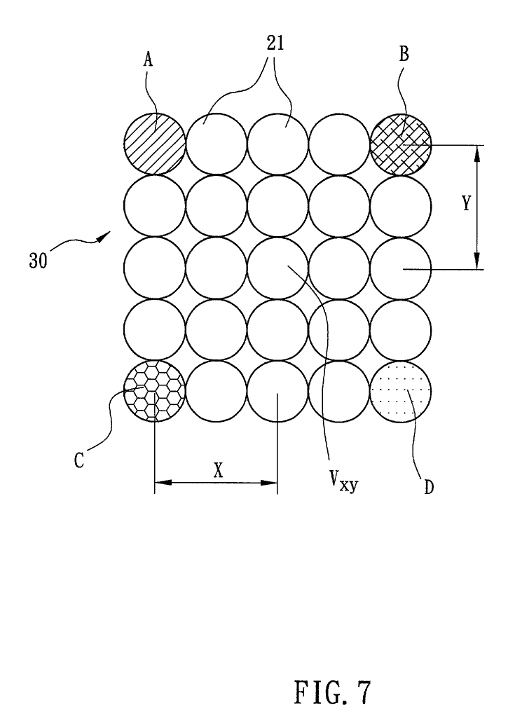

In a preferred embodiment of the present invention, an image processing software is installed into a computer, and the user may execute the image processing software to read a digital video data 30, which will be displayed on the computer screen. Refer to FIG. 6. The user may use a mouse or other input device (such as digitizer and sensing pen) to control the enlarge object 40 provided by the image processing software, and to enlarge the object in the digital video data in order to have a substantial and closer look at the object. Since the color of the 4 pixels A, B, C, and D shown in the four adjacent pixel of the digital video data 30 on such computer screen will be allocated in equal proportion to the four pixels of the enlarged image in the corresponding positions on the computer screen. Refer to FIG. 7. The distance between the four pixels at the corresponding positions is increased by several times compared with the distance between each of the pixel before the enlargement, and the number of pixels included in the four pixels A, B, C, and D on the computer screen will be increase in proportion to the original four. The present invention makes use of the interpolation or point interpolation technologies to simulate at least one simulated pixel V_{XY} according to the additional increased pixels, and the horizontal distance and the vertical distance between the original pixels A, B, C, and D, and allocate the color value of the original pixels A, B, C, and D by weight to the simulated pixel V_{XY} according to Formulae (1), (2), and (3).

P_{AB}=P_{A}*(1−X)+P_{B}*X (1)

P_{CD}=P_{C}*(1−X)+P_{D}*X (2)

P_{XY}=P_{AB}*(1−Y)+P_{CD}*Y (3)

Wherein, X and Y are the proportion of the horizontal distance and the vertical distance from the position of the pixel of the simulated pixel V_{XY} to the position of the original pixels A, B, C, and D of the enlarged digital video data respectively; P_{A}, P_{B}, P_{C}, and P_{D} are the color values of the original pixels A, B, C, and D respectively; P_{AB} and P_{CD} are the color values allocated by the color values of the original pixels A, B, C, and D according to the proportion of the horizontal distance to the color value of the simulated pixel V_{XY}; P_{XY} is the color value of the simulated pixel V_{XY}.

Therefore, when a digital video data is enlarged by the method of the present invention, the compensation of the simulated pixel V_{XY} allows the color value of the simulated pixel V_{XY} to be shown by the extended corresponding pixels between the original pixels A, B, C, and D such that the enlarged image has a finer resolution and better color change, and it also avoids the problems of serrate profile and uneven color, and thus greatly enhances the image quality of the enlarged image.

In another preferred embodiment of the present invention, when the user uses the enlarge object 40 provided by the image processing software to enlarge the digital video data 30 of an object in order to have a finer view of the object, the image processing software will take the position clicked by the input device onto the digital video data 30 as the center of the viewpoint. When the digital video data is enlarged, the enlarged object 40 can simulate the zooming function of a camera, so that users can view any specific portion of the digital video data according to their needs. It totally eliminates the blind spot issue in reviewing and editing.

In summation of the above description, the present invention herein enhances the performance than the conventional method and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing method for enlarging and compensating the pixel of digital video data according to viewpoint, said method relates to an image processing software installed in a computer, which comprises the steps of:
performing an enlargement on a digital video data by simulating at least one pixel between the original plurality of adjacent pixels;
allocating the color value of each original pixel to the simulated pixel by weight according to the distance between the original pixel and the simulated pixel;
thereby the enlarged digital video data has finer resolution and better color due to the compensation of the simulated pixel.

2. An image processing method as claimed in claim 1, wherein said method makes use of an enlarge object provided by the image processing software to select the position on the digital video data as the center of a viewpoint for the enlargement of the digital video data.

3. An image processing method as claimed in claim 2, wherein said method uses a point interpolation technology for the enlargement of the digital video data to simulate at least one pixel between the original plurality of adjacent pixels, and to allocate the color value of the original pixels to the simulated pixel by weight according to the distance between the original pixel and the simulated pixel.

4. An image processing method as claimed in claim 3, wherein said original plurality of adjacent pixels are four adjacent pixels of the digital video data shown on the computer screen.

5. An image processing method as claimed in claim 4, wherein said pixel shown by the adjacent pixels shows a pixel in the range of equal proportion on the screen after the digital video data is enlarged.

6. An image processing method as claimed in claim 5, wherein said point interpolation technology simulates at least one simulated pixel V_{XY} by using the horizontal distance and the vertical distance between the additional increased pixels and the original pixels, and allocates the color values of the original pixels by weight to the simulated pixel V_{XY} according to Formulae (1), (2) and (3):
P_{AB}=P_{A}*(1−X)+P_{B}*X (1)
P_{CD}=P_{C}*(1−X)+P_{D}*X (2)
P_{XY}=P_{AB}*(1−Y)+P_{CD}*Y (3)
, wherein X and Y are the proportion of the horizontal distance and the vertical distance from the position of the pixel of the simulated pixel V_{XY} to the position of the original pixels A, B, C, and D of the enlarged digital video data respectively; P_{A}, P_{B}, P_{C}, and P_{D} are the color values of the original pixels A, B, C, and D respectively; P_{AB} and P_{CD} are the color values allocated by the color values of the original pixels A, B, C, and D according to the proportion of the horizontal distance to the color value of the simulated pixel V_{XY}; P_{XY} is the color value of the simulated pixel V_{XY}.
